(19) United States
(12) Patent Application Publication
(10) Pub. No.: US 2016/0304748 A1
(43) Pub. Date: Oct. 20, 2016

(54) In Situ Formation of Stable Aqueous, Semi-Aqueous or Non-Aqueous Slurry Suspensions of Gelatinous Particles for Separating and Suspending Inert and Abrasive Particles in a Carrier Medium

(71) Applicant: Irl E. Ward, Allentown, PA (US)

(72) Inventor: Irl E. Ward, Allentown, PA (US)

(21) Appl. No.: 15/191,294

(22) Filed: Jun. 23, 2016

Related U.S. Application Data
(63) Continuation-in-part of application No. 12/586,507, filed on Sep. 23, 2009, now Pat. No. 9,394,502.

(51) Int. Cl. C09G 1/02; C10M 103/06

(52) U.S. Cl. CPC C09G 1/02; C10M 103/06; C10M 2201/084; C10N 2250/10; C10N 2240/401

(57) ABSTRACT

A stable aqueous, semi-aqueous or non-aqueous suspension medium to suspend inert organic or inorganic particles in the aqueous or polar solvent carrier containing gel particles as a separating and suspending agent for the inert organic or inorganic particle, which gel particles prevent agglomeration of the inert particles upon settling over extended periods of time.

### RELATED APPLICATIONS

This application is a continuation-in-part of application Ser. No. 12/586,507 filed Sep. 23, 2009, which application remains pending, and is a continuation-in-part of application Ser. No. 12/079,963 filed Apr. 28, 2008 that has now issued as U.S. Pat. No. 7,985,719 which applications are incorporated in their entireties by reference.

### FIELD OF THE INVENTION

The present invention relates to sol or gel particles alone or within a liquid media as a suspension medium. More particularly there is provided a carrier system that possesses long term dispersion stability characteristics for particle suspensions, referred to herein as soft-settle properties, which have uses with a large range of inert particles that can be suspended including abrasive, non-abrasive, inert solid organic particles, ceramic particles, which may be used for lapping applications, wire saw cutting, chemical mechanical polishing and/or planarization in metal forming and finishing, free abrasive grinding, and the like.

### BACKGROUND OF THE INVENTION

Non-aqueous, semi-aqueous and aqueous suspensions of non-colloidal high density abrasive particles have been previously used in wire saw cutting and lapping of wafers, but have been unsuccessful in obtaining a stable slurry suspension of particles capable of maintaining the separation of the inert particles within the suspension over time. U.S. Pat. No. 5,099,820 issued to Stricot discloses an abrasive slurry of a suspension of silicon carbide particles in water or oil. However, the suspensions are not stable and do not provide uniform lubrication and cutting by the wires. Such compositions require vigorous agitation to maintain a uniform suspension of particles, and the suspensions settle out quickly under stagnant conditions even during work-piece slicing while still under agitation.

U.S. Pat. No. 6,602,834 to Ward, et al., which is herein incorporated by reference, discloses a non-aqueous or semi-aqueous cutting and lubricating composition for use with wire saws that relies upon a surfactant, an organic polyelectrolyte and pH to provide electrostatic repulsion and particle-to-particle interference to maintain a stable suspension of abrasive particles. U.S. Pat. No. 6,054,422 to Ward, et al., which is also incorporated herein by reference, discloses a lubricating composition containing up to 70 weight percent abrasive grit material in a suspension utilizing a mixture of high and low molecular weight polyalkylene glycols as a suspension agent.

In the production of Silicon, SiC, Sapphire, GaAs, optical glass, and other wafers used in a variety of industries, i.e., Microelectronics, Solar Cells, L.E.D.'s, broad band-width devices, optics/lasers, wafer polishing, CMP applications, and many others, wafers are cut from larger ingots, bricks, boules, etc. The next step following the initial cut of the wafer, disc, piece, etc., involves the LAPPING of the cut wafer to smooth out the surface, lower the Total Thickness Variation (TTV) which is not applicable to Solar wafers, eliminate damage depth defects, and prepare the wafer for final POLISHING, i.e., primarily applicable to semiconductor and optical wafer production. In general, aqueous carriers are used as the suspension media for the lapping abrasives employed in this step. Lapping abrasives can include, but are not limited to: SiC, Aluminum oxides, ZrO₂, Silicas, CeO₂, diamond, etc. Lapping slurries utilize abrasive particles that are in the size range of about 0.1-10 μm. This means that the suspended abrasive particles are typically non-colloidal in size and nature. This does not exclude the use of colloidal lapping abrasive, i.e., abrasive particles of size range from about 0.001-0.5 μm, but such particles are not typically used in lapping slurries.

The lapping slurry for wafers, mechanical gear sets for the auto industry, ceramics, etc., is subjected to many shear, grinding, and abrasive forces during the wafer lapping process. During the process of “planetary lapping”, the slurry is injected onto the wafer surface, which is held between two large metal, e.g., typically iron and/or steel, plates. Counter rotation of the upper and lower plates holding the wafer compresses the slurry between the upper plate and the wafer surface. The solids within the compressed slurry contact the wafer and angular momentum causes the abrasive action to remove surface wafer defects and “etch” away the desired amount of wafer surface material. With all aqueous slurries used today in lapping, such action on the slurry and the design of the lapping equipment propagates particle agglomeration on the wafer, within the reservoir, within the feed piping, within the lapper, on the metal plates, etc. Such particle agglomeration has the added deleterious effect of producing damaging “dark-scratches” on the lapped wafer. Such wafers must then be discarded at great cost.

Aqueous suspension of non-colloidal, i.e., NCOL, high-density abrasive particles has been a severe and debilitating problem for “wafer” manufacturers for several decades. To date, there exists no low viscosity, water-based carrier that will maintain NCOL abrasive particle suspension for more than an extremely short time period of a few to several minutes. After that, the abrasive particles begin to agglomerate and quickly settle out of suspension at the bottom of the container as a very hard “concrete like” cake. Such abrasive particle settling in presently utilized “aqueous” slurries occurs quickly, even during constant mixing or recirculation.

This particle settling as a “hard settled cake” at the bottom of the container is extremely resistant to any attempts at re-suspension. Any attempt to regenerate slurry, which would maintain the original particle size distribution of the virgin abrasive, cannot be accomplished by simple mixing, agitation, shaking, or the like. As a result, such slurries become unusable and are immediately discarded, wasting expensive abrasive, time, manpower, and effort.

In prior art suspensions, temperature and pH played a factor in the amount of time that a suspension remains homogenous and uniform in extended stagnant storage. Inorganic particles may remain in suspension in aqueous and non-aqueous solvents depending upon the size of the particle, lattice structure and density, but in stagnant storage tend to agglomerate and settle out of suspension. Also, there are no custom made suspending media. Suspending agents remain in the same medium in which they are formed.

It is a general object of the invention to provide a broad diversity of gel particles formed or originated in a large diversity of conditions from many different compounds, polymers, and materials where the “in-situ” formation of the gel particles are under a broad and different set of formation conditions, component material compositions and variable in-situ formation media spanning organic, inorganic and semi-organic matrices; all having the properties to provide long-term inert particle separation and suspension in stable slurry suspensions. These stable slurry suspensions can be used in wire saw applications for the cutting of ingots or other large materials into wafers, discs, or other machined, sliced, ground, or formed pieces; for lapping applications, CMP applications, machining, grinding and milling applications; for automotive metal gear formation applications, optical and opto-electronic slicing, grinding and lapping applications, and in the separation of particles.

It is also an object of the present invention to provide gel particles formed in-situ within a non-aqueous medium and examples are also provided to exhibit the same performance and suspension properties and gel-particle characteristics as those gel particles created in-situ within an aqueous medium. These “non-aqueous” gel particles are preferably comprised of polyacrylic acid, polymaleic acid, polyalkylacrylic acids, or co-polymers thereof that are neutralized or partially neutralized in-situ within an organic medium, preferably polyethylene glycol, polypropylene glycol, diethylene glycol, or other suitable glycols to create a typical gel-particle species within the formation medium that meets the same performance suspension properties of other gel-particles. The gel particles formed in a non-aqueous medium also contain the typical characteristics of gel-particles that are created in-situ within the suspension medium of use or as a “gel-particle” formation medium from which the formed gel-particle is transferred to a second suitable medium for inert or abrasive particle suspension; provided that, the second medium does not react, interact, affect or reduce the suspension performance of the “gel-particle” within the final chosen medium.

It is another object of the invention to provide gel particles having the characteristics to enable the continued separation of inert abrasive or non-abrasive particles in a long-term stable suspension free or ostensibly free from particle agglomeration or coagulation within the suspension, or from collecting as coagulated solids at the bottom of the suspension slurry container, in a low toxicity and/or low to moderate viscosity carrier, wherein the density of said suspension carrier is somewhat less than that of the suspended “gel-particles”. It is yet another object of the invention to provide non-reactive gel particles for a stable suspension of colloidal or NCOL abrasive or non-abrasive particles in a neutral or near neutral pH medium.

A further object of the invention is to provide a means for suspending colloidal or NCOL abrasive or other particles in a liquid not depending upon final slurry viscosity. Another object of the invention is to provide gel particles which can be added to a variety of base carriers for separating and suspending inert particles and also act as lubricants. It is a yet further object of the present invention to provide an aqueous or semi-aqueous carrier/slurry system that will not cause corrosion of metals such as iron, carbon steel, etc.

Other objects will appear hereinafter.

### SUMMARY OF THE INVENTION

The present invention relates to the suspension of particles in a carrier and to sol-gels or gel particles which can be used alone or in an organic or aqueous medium to suspend solid inert particles. Gel particles that include sol-gels, gel particles, gelatinous precipitates, etc., (hereinafter “gel particles”) are used to suspend inert particles and to act as lubricants in a variety of applications as particles alone or in a liquid medium. The suspension slurry composition formed can contain gel particles in amounts ranging from about 0.1% up to about 60% of the carrier by weight. The gel particles and base carrier may be used without the addition of other suspended particles as a lubricant. The aqueous content of the carrier can contain about 1 to 100% by weight of water with an organic solvent added for any carrier less than 100% water. The organic medium can comprise a variety of solvents, preferably alkylene and polyalkylene glycols, depending upon use which is inert and non-reactive with the aqueous medium and the suspending “gel-particles” which include the abrasive material being suspended by the gel-particles. The suspending gel particles have a density similar to or somewhat greater than the carrier-solvent composition.

The gel particles, which are preferably aluminum hydroxide; (Al(OH)₃), magnesium hydroxide; Mg(OH)₂, zinc hydroxide; Zn(OH)₂, copper hydroxide; Cu(OH)₂, and the like for in-situ aqueous formation and suspension usage, can be created in an aqueous or aqueous-based medium, separated and transferred to a second medium, whether aqueous or non-aqueous, or used alone in a variety of cases. The gel particles may be required as a lubricant or to custom formulate a suspension or slurry of stable suspended abrasive or non-abrasive particles that will be referred to collectively as slurries. However, gel particles can be formed with other metal sulfides, hydroxides, and oxide hydrates that can form a suspended precipitate in water within a pH range between 3 and 12.

The invention includes the method for the suspension of inert colloidal or non-colloidal abrasive or non-abrasive inert particles in a stable aqueous, semi aqueous or organic carrier medium. The carrier medium forms the liquid in which suspending particles are in-situ formed so as to establish an appropriate concentration of suspending particles to inert particles to produce sufficient interference to settling of said inert particles in said carrier medium. The carrier medium comprises a range from 0.1 to 60% by weight of the suspending particles, which differ from said inert particles, selected from the group consisting of alkaline earth metal and transition metal hydroxides, oxy hydroxides, and oxide hydrates that are used to form in-situ said suspending particles within and inclusive of said carrier medium at a pH between 4 and 12. The in situ formation of the suspending particles in the carrier medium results in the suspending particles exhibiting a set of substantially uniform properties of having distinctly different molecular, configurational, rheological and physical structures than the carrier medium, a density greater than that of the carrier medium, visually identifiable and separate physical structure than the carrier medium, measureable size differences in a range between approximately 2-3 μm and 500 μm, and containing molecules of the carrier medium within which the suspending particle was formed, but without any further chemical reaction with the carrier medium, though an interaction between the gel-particle structure and the internally contained carrier molecules is both possible and probable. Finally, the suspending particles exhibit these properties independent of their formation mechanism or origin of components.

As a direct result of the in situ formation of the suspending particles the inert particles are suspended in the carrier medium by at least one of physical interference between the suspending particles and the inert particles, attracting forces between the suspending particles and the inert particles to provide a proximity for chemical, physical or physicochemical interference, and electrostatic charge repulsion of the suspending particles from the inert particles and themselves, all to prevent agglomeration and coagulation of said inert particles in said carrier medium over an extended period of time.

The components from which the in situ formed suspending particles are formed, which can be gel particles, sol-gel particles or gelatinous precipitates of a number of chemical compounds, are described in greater detail below. In addition, depending upon the composition of the components of the suspending particles, the suspending particles may be formed in a separate medium from the final carrier medium.

### DESCRIPTION OF THE PREFERRED EMBODIMENTS

The present invention provides a means for providing a broad variety of gel particles formed or originated under a large diversity of conditions from many different compounds, polymers, and materials where the “in-situ” formation of the gel particles are under a broad and different set of formation conditions, component material compositions, and variable in-situ formation media spanning organic, inorganic and semi-organic matrices providing a stable suspension of inert or abrasive particles in an aqueous, semi-aqueous or organic medium, without agglomeration or particle hard settling utilizing sol-gels or gel particles, and for the express purpose of cutting, slicing, machining, grinding, milling, lapping, re-shaping, preparing finished pieces of hard materials into finished pieces such as, but not limited to wafers, discs, specialty hard metal, semi-metal, or ceramic parts from larger hard material pieces by the use of a stable cutting, slicing, grinding, etc. slurry made stable by virtue of the unique “stability properties” of the gel particles.

According to one feature of the invention there is provided suspension and/or lubricating carriers and slurry compositions for wire saw applications such as cutting or slicing slurries, lubricants, lapping or polishing slurries, non-abrasive slurries, and the like in which a suspension of particles is maintained at ambient as well as elevated temperatures. The gel particles are maintained as an aqueous, semi-aqueous, or non-aqueous suspension in about 0.1 to 80 weight percent of the carrier medium which provides for sufficient particle-to-particle interference against agglomeration or hard settling of the abrasive or inert particle with a “gel-particle” density somewhat greater than the density of the carrier medium. The gel particles can be prepared separately and then used alone or in a carrier as a lubricant and/or suspension agent or combined with an appropriate polar or non-polar solvent depending upon the suspension compatibility of the gel-particle with the carrier medium. As an example, the gel particles can advantageously be used in different types of glycols so that the lubricating compositions can be custom made for a particular use.

It is desirable in many cases to use more than one suspending agent in order to have a uniform dispersion for as long as possible. The reason for this is that the particles to be suspended may have different densities and/or electrostatic charges from the suspending gel particles. For example, in wire saw cutting operations there are cutting particles and kerf particles from the ingot being cut. In other operations there can be contaminants with higher density or similar density as the suspending medium.

These suspending particles, for the aqueous example case, are in situ formed alkaline earth metal or transition metal hydroxides, oxy-hydroxides, and oxide hydrates (also referred to as hydrous oxides) that form a suspended particulate precipitate, i.e., sol-gels, gel particles, gelatinous precipitates, etc., in aqueous or semi-aqueous media at a pH in a range from about 3 to 12. The particles to be suspended comprise the conventional abrasive or non-abrasive particles, inert particles having a particle size of about 1 to 100 μm for pigment manufacture, wire saw cutting, metal finishing applications and smaller size for wafer lapping applications being in the range typically of about 0.1 to 10 μm, and even lower for CMP applications, the particles being the range of about 10-500 nm. The preferred suspending particles are those formed in situ or separately such as when a metal salt is formed into the metal hydroxide. In such a case, the density of the in-situ prepared precipitated gelatinous “gel particles” is greater and the surface area of the gel particle formed in-situ is typically less than “dried” commercially available forms, if such forms are available at all. The in-situ formed gel particles usually will retain a higher density than the in-situ carrier medium, or any second medium wherein the formed “gel particles” are placed. In addition, there is generally a broader particle size distribution of the in-situ formed gel particles of the invention. The advantage of having the gel particles separate from the carrier medium allows for mixing different particle sizes in certain applications particularly for use in coatings.

The abrasive material for use in the above-recited composition may include powders of diamond, silica, tungsten carbide, silicon carbide, boron carbide, silicon nitride, silicon dioxide, cerium oxide, zirconium oxide, aluminum oxide, or other hard grit “powder” material. Generally, mean or average particle sizes range from about 0.5-100 microns and preferably from about 2-50 microns, or a mixture thereof. The concentrations of the inert particles being suspended in the suspension medium or carrier for most applications typically may range from about 0.1 to 60 weight percent of the total suspension.

Solvents which may be used with aqueous media are polar solvents which include alcohols, amides, esters, ethers, ketones, glycols, glycol ethers, alkyl lactones, or sulfoxides. Specifically, examples of polar solvents are dimethyl sulfoxide (DMSO), dimethylacetamide (DMAC), N-methyl pyrrolidone (NMP), (gamma) y-butyrolactone, diethylene glycol ethyl ether, dipropylene glycol methyl ether, tripropylene glycol monomethyl ether, various glycols, polyethylene glycols and polypropylene glycols, and the like.

The organic solvents are used in some cases to provide needed viscosity levels to the resulting slurries being prepared. Other uses for organic solvents may include a lowering of the slurry/carrier freezing point. The choice of the solvent is relatively immaterial as long as the solvent is inert, fully miscible or soluble in water, for the case of aqueous formed gel-particles, non-reactive with water or with the suspended particles or suspending gel particles, and has low toxicity and is of low odor.

The suspending particles in the aqueous formed gel-particle case, that can be used include, but are not limited to, metal hydroxides, oxide hydrates (or hydrous oxides) and oxides other than the abrasive particles that form an aqueous or semi-aqueous suspension, i.e., gel particles, gelatinous precipitates, sol-gels, colloidal or non-colloidal suspensions, etc. These suspending particles, as an important component of the present invention, may settle down toward the bottom of the container over time, but will not settle out over time to form a hard agglomerate or particle “cake” on the container bottom. This includes, but is not limited to those compounds, which in-situ are within or without the medium converted to the hydroxide form such as a metal sulfate that is converted to the hydroxide form using a metal or non-metal Bronsted base, for example, potassium hydroxide, tetramethyl ammonium hydroxide, sodium hydroxide, sodium carbonate, tetraethylammonium hydroxide/carbonate, etc. as illustrated by the following example equation:

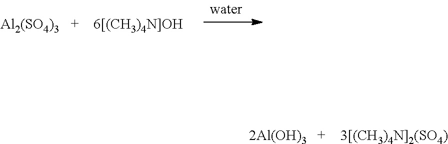

An insoluble fully suspended gelatinous precipitate or precipitates of aluminum are formed with a pH ranging between about 4 and 12.

Among the suitable metal hydroxides of use for the aqueous formed gel-particle example of this invention include, but are not limited to copper hydroxide, aluminum hydroxide, barium hydroxide, ferrous or ferric hydroxide and Zn(OH)₂. Among the metal sulfides, salts or oxide hydrates which may be used to form, or form in-situ the suspending particles in the aqueous example of this invention are transition metal oxides such as Zn-salts, ZnS, SnO₂xH₂O, tin-salts, SnS, Al₂O₃xH₂O, Al-salts, and the like. These salts, sulfides, oxy-hydroxides, oxide hydrates (or hydrous oxides), and the like can also be used to form the corresponding hydroxides to provide a stable suspension medium that includes sol-gels, gel particles, and gelatinous particles suspension for the aqueous carrier system example of this invention. In the case of Al(OH)₃ or other aluminum oxide or hydroxide species, a pH range for use in the carrier is about 3-12. A preferred pH range is 5-10 and the most preferred pH range is 6-9.

Included as suspending precipitates or gel-particles are those particles having a density greater than that of the carrier solvent, and those that are naturally precipitous or suspendable. It is understood that there are those metal oxy-hydroxides, hydroxides or hydrous oxides which have a higher density except when formed or precipitated in-situ in the aqueous or semi-aqueous medium which is then added to the carrier systems of this invention.

To quantitatively determine the level of “soft-settle” characteristics of an abrasive slurry, e.g. SiC slurry, a precise measurement tool was employed. The slurry stability of a particular suspension carrier is gauged by its soft-settle retention characteristics (SSR) or, in other words, the resistance of solids suspension to form a hard cake at the bottom of the container. It is also gauged by its suspension volume retention (SVR) which measures how efficiently the solid particles remain separated from each other in suspension. In order to determine if a carrier can create a stable slurry, a slurry containing 15-25% silicon carbide (SiC) JIS 1000 grade, i.e., an average particle size between approximately 13-16 μm, was prepared and stored in 50 mL graduated tubes with a conical bottom at ambient and 50° C. with both the SSR and SVR measured over an extended period of time.

The soft-settle retention characteristic was measured using an IMADA Vertical Manual Lever Force Test Stand, Model LV-100. The IMADA measures the force required for a probe with a standard diameter circular pad at the shaft bottom to pass through the slurry and reach the bottom of the container. In order to measure the force required, the set up of the IMADA was modified by lengthening the probe shaft so that the probe could extend into and reach a point within 1 mm of the conical bottom of the graduated tube; that bottom having a diameter less than 1 mm greater than the diameter of the circular probe bottom. The probe was lengthened by attaching an elongated threaded rod to the probe. The force measured by the IMADA is reported in hundredths of pounds. A low SSR indicates that the abrasive can be easily re-suspended, and a high value such as greater than 1.0 indicates that the abrasive has hard settled and cannot be easily re-suspended.

The suspension volume retention [SVR] is calculated by measuring the volume of the solid occupied within the tube in mL, dividing that volume by the overall volume of the slurry in the graduated tube in mL, and multiplying the result by 100 for a percentage reading. In general, but not always, the higher the SVR value, i.e., the closer to 100%, the better the ability of the carrier to hold the abrasive in suspension. The SVR of a slurry generally decreases over time, but is not necessarily indicative of the soft-settle characteristics of the slurry. On an irregular basis, the SVR reading will not coincide with expected values under the conditions of the “soft-settle” experiment for the slurry under study. This means that, although the SVR may be a qualitative indicator, it does not provide consistent values expected for a “soft-settled” slurry in contrast to the far more accurate, consistent and quantitative soft settle characteristics [SSR] values. Therefore, SVR is often, but not always indicative, but is not a quantitative criteria, as SSR is, of the overall stability of the slurry.

As an example of the extent of stabilization of abrasive slurries suspended by typically formed gel particles described as part of this invention, and of the irregular counter intuitive relationship between SSR values for stored slurry over an extended term vs. the SVR for the same slurry, the following case is exemplary.

An ostensibly non-aqueous “gel-particle” suspension carrier was formed in-situ within PEG-200 in the following manner. The suspension gel-particles were formed by the partial neutralization of a co-polymer of acrylic acid and maleic acid with a final molecular weight of >3000D. Said polymer was initially purchased as a 50/50 (wt/wt) aqueous solution, and added to the suspension carrier, PEG-200, where a clear to slightly cloudy “solution” of the co-polymer acid was made. This polymer acid was partially neutralized using an amino-hydroxide base until the proper “gel-particles” were formed within the PEG suspension medium at a concentration sufficient to suspend ˜48% SiC abrasive on a wt/wt. basis.

The slurry was used to cut many Si ingots into wafers, after which the slurry became “exhausted” and was stored within 300 gal. 4′×4′×4′ containers with a total weight exceeding 3000 lbs. per container. The spent slurry was “cold stored” in an environment without temperature and/or humidity control in a stagnant mode for 4 years. Using a 5′ long steel shaft with a circular disc at the shaft end with a diameter of ˜8″ (an oversized IMADA rod), the “soft-settle” characteristics of the long-term stored spent slurry was qualitatively measured by slowly dropping the “IMADA rod” without any external force downward into the slurry within each container to qualitatively determine the hardness of the settled solids. SVR for these solids was measured to be <30%. The IMADA rod successfully dropped to the very bottom of the slurry within the containers without any external force, demonstrating an SSR of ˜0 even after 4 years of stagnant storage.

This experiment was repeated on at least one dozen other glycol-based, non-aqueous spent slurry storage containers with similar results in all cases. Such “soft-settling” for a high solids loaded slurry after a period of 4 years clearly demonstrates the effectiveness and persistence of the concept of “gel particle” separation and suspension properties of the present invention.

In order that the measurement tool utilized for determining soft-settle resistance (SSR) accurately measures “cake-penetration resistance” in a repeatable and precise manner, both standard rod penetration depth and calibration of the tool were checked daily. For a slurry formed within an excellent suspension carrier, the SSR of penetration was expected to be low, on the order of <0.1 lbs. over long storage periods under controlled test conditions ranging over a period of up to four to six weeks. For slurries formed within poor suspension carriers without the presence of “gel-particles”, e.g., standard PEG-200, -300, or -400, or water, the soft-settle resistance was measured to be typically high in the range of 1.5-2.0 lbs. within quite short storage time periods of one to multiple days. In other words, the lower the SSR for a given slurry over time, the more stable, uniform, and better the slurry with respect to performance, stable storage capacity, prevention of coagulated or agglomerated solids over time, slurry suspension maintenance, and recyclability and ease of original slurry suspension characteristics after long storage times.

Because the invention relates to aqueous, non-aqueous and semi-aqueous media, extended contact of formulations of this invention with metals such as carbon steel, iron, spring steel, etc. that are typical components of wire saws, metal finishing lappers, wafer lappers, etc., can result in corrosion or rusting of such metals. A corrosion inhibitor may be added to the carrier formulations of the present invention to suppress or eliminate metal corrosion when required. Appropriate inhibitors should not cause foaming, interfere with the formulations' ability to provide long-term stable abrasive or solids suspensions, or compromise the viscosity, rheology, or uniformity of the carrier formulations and their associated abrasive or solids suspensions.

Suitable corrosion inhibitors which may be added to the aqueous and semi-aqueous carriers of the present invention may include, but are not limited to, aliphatic and aromatic carboxylic acids, neutralized carboxylic acids using alkanol amines (i.e., diethanol amine, mono-ethanol amine, etc.), tetra-alkylammonium hydroxides, other similar non-metal hydroxide bases, alkyl or aromatic amines, or other Bronsted bases. Also included may be other metal corrosion inhibitors known in the art such as long chain modified carboxy!ates commercially available under such trade names as DeForest DeCore-APCI-95, DeTrope CA-100. Further examples of known corrosion inhibitors equally suitable for the corrosion prevention or suppression of metals used in CMP processes (i.e., Al/Cu, Cu, Al/Si, Al/Si/Cu, GaAs, LnP, and the like) may include but are not limited to benzoic acid, pyrogallol, gallic acid, ammonium thiosulfate, 8-hydroxy quinoline, catechol, benzotrizole, triethanolamine, imadazoles (ie; such as benzimidazole and alkyl-substituted benzimidazoles, et. al.), thiophene compounds such as Sulfolane, modified polyacrylic acids or polyacrylates, polysaccharides, polyalcohols such as polyvinyl alcohol, etc., or combinations thereof. Additionally, there are other suitable corrosion inhibitors which function as oxygen absorbers or scavengers which include but are not limited to p-hydroquinone (i.e., p-quinol), polyhydroxy aromatics such as catechol or gallic acid, 8-hydroxyquinoline, nitrites, sulfites, ascorbic acid, etc.

The selection of the corrosion inhibitors for the purpose of this invention is immaterial as long as the inhibitor meets the above mentioned performance criteria including:
suppress or eliminate metal corrosion;
does not cause noticeable foaming of the carrier or resulting slurry;
does not compromise or interfere with the ability of the suspension carrier to provide long-term stability of the slurry;
does not deleteriously effect viscosity, performance or rheology of the carrier or resulting gel particle or inert solids suspension;
does not deleteriously effect the uniformity or homogeneity of the carrier suspension or the gel particle or inert solids suspension within the carrier;
does not chemically react with either the base medium or the gel particles of the carrier or the inert particles as a slurry being suspended by the gel particles.

Certain of the salts which are generated as a by-product of the reaction to form the gel particles may appropriately increase the ionic strength so as to aid in the repulsion and increase the settling time of the suspended inert particles given the right concentration and structure of said generated salt. However, it may also be advantageous to rinse out the generated dissolved salt formed during the gel particle formation, depending upon the application of the overall slurry suspension, leaving only the in-situ formed gel particles in the neutralized or partially neutralized base medium, preferably water in this case.

The following examples are illustrative of the practice of the method of the present invention. It will be understood, however, that the listed examples are not to be construed in any way limitative of the full scope of the invention since various changes contained herein in light of the guiding principles which have been set forth above. All percentages stated herein are based on weight except where otherwise indicated.

### EXAMPLE 1

A. Preparation of Gel Particles—Solid Aluminum sulfate hexadecahydrate was added to tap water so that the percent aluminum sulfate in the water was 10.76%. This solution was neutralized with a 25% solution of tetramethyl ammonium hydroxide (TMAH) to a pH of 7.7 under constant mixing over a time period of 30 minutes. The resulting Al(OH)₃ gel particles appear as a white cloudy suspension. The suspension is then rinsed with water 3-times to remove dissolved by-product salt in the suspension. The resulting carrier suspension has very low or no ionic character/properties.

B. Preparation of Suspension Slurry of Abrasive Particles—The gel particles of Part A were filtered and added to this concentrate of gel-particles is an aqueous carrier to make a specific gel-particle concentration. To this aqueous suspension is added dried titanium oxide solids for a total solids loading of 25%, for use as a coating composition containing ˜10% gel particles. The formulation soft-settle resistance (SSR) and suspension volume retention (SVR) data are shown below in Tables 1a and 1b.

TABLE 1a
Formulation Data

| | | g solid | | % | |
|---|---|---|---|---|---|
| % Solid | g Tap | equiv. | g 25% | Abrasive | |
| Al₂(SO₄)₃•16 H₂O | Water | Al₂(SO₄)₃ | TMAH | Loading | pH |
| 10.8 | 267.7 | 32.2 | 99.25 | 15 | 7.69 |

TABLE 1b
Viscosity, SSR and SVR Data

| | Viscosity @ | | Ambient Soft-Settle & SVR | | | | 50° C. Soft-Settle & SVR | | | |
|---|---|---|---|---|---|---|---|---|---|---|
| % Solid | 25° C. (cP) | | Day 1 | | Week 4 | | Day 1 | | Week 4 | |
| Al₂(SO₄)₃•16H₂O | Carrier | Slurry | % SVR | SSR | % SVR | SSR | % SVR | SSR | % SVR | SSR |
| 10.8 | 16 | 74 | 66 | 0 | 42 | 0 | 56 | 0 | 51 | 0 |

The SSR reading for the TiO2 solids suspended slurry of “zero” demonstrates an excellent suspension. The ambient SVR reading of 42% at the end of four weeks with an SSR value at all measured points of “0” is consistent with a well “soft-settled” suspension.

### EXAMPLE 2

A. Preparation of Gel Particles—Solid aluminum sulfate octadecahydrate was added to tap water so that the concentration of active aluminum sulfate in water was 15.5%. This solution was slowly and uniformly neutralized under constant mixing with KOH (25% solution in water) to a pH of 7.7. The in-situ formed gel particles appear as a white cloudy suspension within the water base.

B. Preparation of Suspension Slurry of Abrasive Particles—A slurry of ˜48% abrasive SiC particles of mean particle size ˜9-10 μm is suspended within the gel particle carrier prepared in (A) above. The suspension is thoroughly mixed and let stand under both ambient and elevated temperature conditions to determine the soft-settle and suspension uniformity characteristics. The formulation, viscosity, soft settle retention (SSR) and suspension volume retention (SVR) data are listed in the following tables. Again, the SSR and SVR readings demonstrate an excellent stable particle suspension, even after 4 weeks. However, it will be noted that the SVR is typically expected to be lower at elevated temperature than that for the ambient analog of the same slurry. In this case, as mentioned earlier, the SVR, though indicative of a stable “soft-settled” slurry does not produce the quantitative or qualitative readings expected, that is “ . . . though the SVR may be a qualitative indicator, it does not provide the consistent values expected for a “soft-settled” slurry . . . .”

TABLE 2
Viscosity, SSR, and SVR

| | | | Ambient Soft Settle & SVR | | | | | | | |
|---|---|---|---|---|---|---|---|---|---|---|
| | Viscosity at 25° | | for Slurry | | | | 50° C. Soft Settle & SVR | | | |
| % Solid | (cP) | | Day 1 | | Week 4 | | Day 1 | | Week 4 | |
| Al₂(SO₄)₃ | Carrier | Slurry | SVR % | SSR | SVR % | SSR | SVR % | SSR | SVR % | SSR |
| 15.5 | 29.4 | 236.5 | 71 | 0 | 58 | 0 | 71 | 0 | 74 | 0 |

### EXAMPLE 3

Solid aluminum sulfate octadecahydrate was added to tap water so that the concentration of aluminum sulfate in water was 15.54%. This solution was neutralized with KOH (25% solution in water) to a pH of 7.7. Added to this white cloudy carrier system is 48% by weight of SiC particles of average size ˜8-9.5 μm. The entire suspended slurry is mixed thoroughly for ˜5 min. The formulation, viscosity, SSR, and SVR data are listed in the following tables.

TABLE 3a
Formulation Data

| % Solid | | g 0.4M | g 0.5M | |
|---|---|---|---|---|
| Al₂(SO₄)₃•18 H₂O | g Tap Water | Al₂(SO₄)₃ | NaOH | pH |
| 15.54 | 253.37 | 46.62 | 146.03 | 7.73 |

In lieu of aluminum sulfate, zinc sulfate or stannous sulfate can be used. The gels which are formed can be filtered and mixed to be used in different liquid mediums. Similar results in terms of slurry stability to those of previous examples were observed. However, in this example, the SVR of 71 after 4 weeks at 50° C. illustrates an exceptionally stable slurry.

TABLE 3b
Viscosity, SSR and SVR Data*

| | | | Ambient Soft Settle & | | | | 50° C. Soft Settle & SVR | | | |
|---|---|---|---|---|---|---|---|---|---|---|
| | Viscosity at 25° | | SVR of Slurry | | | | of Slurry | | | |
| % Solid | (cP) | | Day 1 | | Week 4 | | Day 1 | | Week 4 | |
| Al₂(SO₄)₃ | Carrier | Slurry | SVR | SSR | SVR | SSR | SVR | SSR | SVR | SSR |
| 15.54 | 29.4 | 236.5 | 71 | 0 | 58 | 0 | 71 | 0 | 49 | 0 |

*SVR is always given as a percent of total slurry volume

Inert salts may be added to provide additional electrostatic repulsion of particles. Also, dissolved salt created by the gel particle formation may be rinsed out with water or the appropriate carrier medium solvent to create a gel particle suspension with comparatively little or no ionic character.

### EXAMPLE 4a

A. Preparation of Gel Particles—In this example, instead of using tap water as the solvent, a semi-aqueous solvent employing diethylene glycol (DEG) was used. Because aluminum sulfate is not soluble in DEG, a water solution of aluminum sulfate must be prepared before it is added to the DEG. The Al(OH)₃ gel-particles are typically prepared in water and, once formed, the gel particles are added to another solvent like DEG. In this case, a 0.4M solution of aluminum sulfate was prepared and neutralized with a 25% water solution of TMAH to a pH of ˜7.8-8.8. The gel-particles were separated from the in-situ water medium, and then added to DEG to provide a “gel-particle” suspension appropriate for the suspension of a lapping abrasive. The SSR, SVR and viscosities were measured. The soft-settle measurement tubes were prepared with 18% zirconium oxide (ZrO₂) instead of SiC. The measurement results are provided in the following Tables 4a-1 and 4a-2.

TABLE 4a-1
Formulation Data

| | | | Weight | Weight | |
|---|---|---|---|---|---|
| % Solid | % 0.4M | Weight of | of 0.4M | of 25% | |
| Al₂(SO₄)₃ | Al₂(SO₄)₃ | DEG* (g) | Al₂(SO₄)₃ (g) | TMAH (g) | pH |
| 0.49 | 2.03 | 386.16 | 7.99 | 5.84 | 8.01 |
| 0.99 | 4.12 | 703.91 | 30.25 | 22.09 | 8.05 |
| 1.50 | 6.28 | 589.22 | 39.45 | 28.83 | 7.80 |
| 2.03 | 8.5 | 566.14 | 52.57 | 38.42 | 7.79 |
| 2.58 | 10.77 | 336.74 | 40.66 | 29.20 | 8.80 |

*DEG = Diethylene Glycol

The SSR results in Table 4a-2 demonstrate that at ambient temperature, a stable suspension exists after one week when the starting amount of active Al₂(SO₄)₃ exceeds 2.0%. In this case the SVR=0.16, which is indicative of a very “soft-settled” and stable suspension. At 50° C., even an AIS level of 0.49% produces a stable suspension after one week.

TABLE 4a-2
SSR and Extended SSR Data

| | Viscosity at 25° C. | | | | | |
|---|---|---|---|---|---|---|
| | (cP) | | | | | |
| % Active | | Slurry | Ambient SSR | | 50° C. SSR | |
| Solid | | with 18% | Day 1 | Week 1 | Day 1 | Week 1 |
| Al₂(SO₄)₃ | Carrier | ZrO₂ | SSR | SSR | SSR | SSR |
| 0.49 | 31 | 212 | 0 | 1.16 | 0 | 0.21 |
| 0.99 | 49 | 218 | 0 | 1.24 | 0 | 0 |
| 1.50 | 27 | 217 | 0 | 1.03 | 0 | 0.51 |
| 2.03 | 34 | 353 | 0 | 0.16 | 0 | 0 |
| 2.58 | 32 | 330 | 0 | 0 | 0 | 0 |

### EXAMPLE 4b

A. Preparation of Gel Particles—In this example, as shown immediately above in Example 4a, instead of using tap water as the solvent, a semi-aqueous solvent employing propylene glycol methyl ether (PGME) was used. Because stannous sulfate is not sufficiently soluble in PGME, a water solution of stannous sulfate is prepared within which the Sn(OH)₂ gel particles are prepared before it is added to the PGME. In this case, a 0.5 M solution of stannous sulfate was prepared and neutralized with sufficient 25% aqueous TMAH to give a pH of 7.9. The gel particles were filtered and the wet gel solids were stored for 4 weeks under closed conditions to maintain the water content within the wet gel solids.

B. Preparation of Suspension Slurry of Coating Particles—The wet gel particles were then added to a 2:1 mixture of PGME to water so as to be 33% of the total mixture. To the mixture titanium dioxide was added in equal amounts of weight as the gel particles to form a coating composition. An appropriate amount of tetramethyl ammonium sulfate may be added to provide additional electrostatic repulsion between suspended particles.

### EXAMPLE 4c

The purpose of the following formulations is to lower the viscosity of the formulation described in Example 4a by diluting the carrier with tap water. The carrier was diluted 25% and 50% with water, keeping the concentration of aluminum sulfate constant between various dilutions. For this example, 50% dilution is reported in the Tables below. The soft-settle tubes were prepared with 18% zirconium oxide (ZrO₂) instead of SiC. The measurement results are provide in Tables 4c-1 and 4c-2.

TABLE 4c-1
Formulation Data

| % Solid | Weight of Carrier | Weight of Tap | |
|---|---|---|---|
| Al₂(SO₄)₃ | of Example 4a (g) | Water (g) | pH |
| 0.25 | 140 | 140 | 7.77 |
| 0.50 | 140 | 140 | 7.86 |
| 0.75 | 140 | 140 | 7.63 |
| 1.01 | 140 | 140 | 7.71 |
| 1.29 | 140 | 140 | 7.61 |

The SSR results in Table 4c-2 demonstrate a minimally acceptable reading for soft-settle properties of the ambient temperature slurry when the percent aluminum sulfate content used to form the “Al(OH)₃” in-situ gel particles in aqueous medium is greater than about 0.75%. At 50° C., the SSR indicates a stable soft-settle slurry after one week when the percent aluminum sulfate content is greater than 0.50%.

TABLE 4c-2
Viscosity, SSR & SVR Data

| | Viscosity at 25° C. | | | | | |
|---|---|---|---|---|---|---|
| | (cP) | | | | | |
| | | Slurry | Ambient SSR | | 50° C. SSR | |
| % Solid | | with 18% | Day 1 | Week 1 | Day 1 | Week 1 |
| Al₂(SO₄)₃ | Carrier | ZrO₂ | SSR | SSR | SSR | SSR |
| 0.25 | 6 | 63 | 0 | 1.3 | 0 | 1.6 |
| 0.50 | 8 | 73 | 0 | 1.5 | 0 | 1.16 |
| 0.750 | 10 | 86 | 0 | 0.76 | 0 | 0.53 |
| 1.01 | 9 | 87 | 0 | 1.1 | 0 | 0.14 |
| 1.29 | 16 | 185 | 0 | 0.73 | 0 | 0 |

This example demonstrates that the content of suspending gel-particles must be sufficient to physically and/or physicochemically interfere with the settling of the level of abrasive or inert particles contained within the subject slurry. When the “gel-particle” content is less than required to properly prevent abrasive particle agglomeration, coagulation and hard settling, a hard settled cake that shows significant resistance toward penetration is created, and the slurry becomes un-useful for uniform slicing, cutting, grinding, or lapping hard materials into desired shapes, surface quality, wafer or sliced disc cutting from a larger ingot or brick in a consistent and uniform manner.

### EXAMPLE 5

The separated gel particles prepared in accordance with Example 2, Step A were combined with enough PEG200 to yield a wet gel-particle concentration of ˜30% wt/wt. To this is added sufficient water to dilute the carrier suspension by 25%, 50% and 75% to provide three different gel particle concentrations between the three different dilutions. For this example the variation in overall pH, SSR and SVR is reported in Table 5 below. 18% zirconium oxide (ZrO₂) was added to the mixture consistent with other examples herein, and slurry properties measured. The measurement results of the various dilutions are listed in the following table.

TABLE 5
Formulation, SSR & SVR Data*

| % Al₂(OH)₃ | | | | % Gel | | Slurry SSR |
|---|---|---|---|---|---|---|
| Wet Gel | Weight of | Weight of | | Particles in | | (SVR) after |
| Particles in | Carrier from | Tap Water | % Carrier | Diluted | | 3 weeks |
| Carrier | Ex-4c (g) | (g) | Dilution | Carrier | pH | (18% ZrO₂) |
| 30 | 140 | 140 | 50 | 15 | 7.77 | 0 (52%) |
| 30 | 140 | 46.7 | 25 | 22.5 | 7.86 | 0 (61%) |
| 30 | 140 | 420 | 75 | 7.5 | 7.43 | 0 (41%) |

*SVR is a percent of total slurry volume

The gel particles that are being described are essentially malleable or gelatinous particles that are formed in-situ within a suspending medium, or may be formed outside the final suspending medium, but is mixed, exposed, or otherwise directly interacts with the suspending medium such that a physico-chemical reaction, absorption interaction, electrostatic interaction or other “combining” mechanism between the formed gel particle and the suspending medium takes place to form the final gelatinous, malleable particle that becomes suspended within said medium.

### EXAMPLE 6

A. Preparation of Gel Particles—In this example, instead of using an aqueous solvent, a non-aqueous solvent employing Polyethylene glycol (PEG-200) was used. Further, instead of an “in-situ” prepared metal hydroxide as the suspending gel-particle, a partially neutralized organic polymer is used to create the suspending “gel-particle” within the non-aqueous PEG-200 solvent.

B. Preparation of Suspension Slurry of Abrasive Particles—The suspension gel-particles were formed by the partial neutralization of a co-polymer of acrylic acid and maleic acid with a final molecular weight of >3000D. The polymer was initially purchased as a 50/50 (wt/wt) aqueous solution, and added to the suspension carrier, PEG-200, where a clear to slightly cloudy “solution” of the co-polymer acid was made. This polymer acid was partially neutralized using an amino-hydroxide base until the proper “gel-particles” were formed within the PEG suspension medium at a concentration sufficient to suspend ˜47% SiC abrasive on a wt/wt. basis. For the above prepared non-aqueous slurry, the key formulation parameters, soft-settle resistance (SSR) and suspension volume retention (SVR) data are shown below in Tables 6a and 6b.

TABLE 6a
Formulation Data

| % Acrylic Polymer | | g amino- | Carrier | | wt/wt % | Slurry |
|---|---|---|---|---|---|---|
| “gel-particles” | | hydroxide | Viscosity | | Abrasive | Viscosity |
| (#11383) | g PEG-200 | base | cP | pH | Loading | cP |
| 0.9-1.0 | 446 | 13 | 73 | 5.3 | 47.5 | 300-320 |

TABLE 6b
Viscosity, SSR and SVR Data

| | Viscosity @ | | Ambient Soft-Settle & SVR | | | | 50° C. Soft-Settle & SVR | | | |
|---|---|---|---|---|---|---|---|---|---|---|
| % Gel- | 25° C. (cP) | | Day 1 | | Week 4 | | Day 1 | | Week 4 | |
| Particles | Carrier | Slurry | % SVR | SSR | % SVR | SSR | % SVR | SSR | % SVR | SSR |
| 0.9-1.0 | 74 | ~310 | 87 | 0 | 61 | 0 | 79 | 0 | 51 | 0 |

It is to be understood that a gel particle is not considered to be an emulsion, sol, or gel. It is a distinct “gelatinous” particle that actually contains within it some of the molecules of the liquid medium from which it was formed using any of the above or other mechanisms to form the gelatinous particle. The gel particle is partially solid, but not a suspended liquid as in the case of emulsions. Gel particles for the purpose of this invention will have common properties regardless of the differences in actual gel particle chemistry or the mechanism by which it was formed.

The gel-particle is a separate and distinct molecular and physical structure having different properties that are separate and independent of the overall medium within which it was formed by whatever means employed, implemented or used to form the “gel particle”. Gel particles may be formed in very different suspension or carrier mediums using compounds, polymers, oligomers, organic or inorganic materials that have no other similar characteristics between them other than those properties that are typical to the resulting formed “gel particles”.

To state this in a different way the particle that has been created exhibits similar characteristics regardless of the different media in which it was formed, for example:
1) A highly ionic organic suspended polymeric particle that is both physically, configurationally, molecularly, and in terms of “charge” greatly different from the PEG “glycol” medium within which it is originally formed.
2) A very low ionic inorganic suspended non-polymeric particle that is both physically, configurationally, molecularly, and in terms of “charge” greatly different from the “water-based” medium within which it is originally formed.
   Regarding the two examples immediately above, these are two vastly different “molecular species” of gel particles that were formed in significantly different mediums that have similar formation steps that can be listed as follows:
a) the gel particles are prepared using similar methods;
b) the gel particles are prepared “in-situ” within their suspending medium;
c) the gel particles are created as a separate and distinct molecular environment existing within the very different molecular environment of the medium from which they were created;
d) the gel particles have densities that are somewhat greater than the densities of the mediums within which they were formed;
e) the gel particles efficiently and effectively suspend inert particles by means of physical interference, density differences, electrostatic charge contributions (in repulsion) and gel-particle-to-inert particle interactions, such as mechanical, secondary (i.e., inter- and intra-molecular charge distribution effects (dipole forces), hydrogen bonding forces or Van der Walls forces) resulting in attachment and/or physicochemical particle interference;
f) the gel particles are prepared by chemical interaction or chemical reaction with another molecule within the separate and distinct “in-situ” medium within which they are formed.

These gel-particles, regardless of what medium they are formed in, or just what components form the final gel-particles, also have very similar and distinct characteristics or properties from other forms of matter, which include the following: The gel particles are always formed in-situ within a carrier medium of distinctly different molecular, configurational, rheological and physical properties than the gel-particle itself. Even gel particles that are initially formed outside the final carrier medium, e.g.; such as some polysaccharides, which may be exposed, interacted, mixed or reacted with the carrier for an appropriate time to form the final gel particle. Therefore, the final gel particle can still be termed as being formed in-situ with the carrier medium. The gel particles have densities that are always somewhat greater than the medium from which they were formed, since they contain part of that medium within their structure and will tend to settle down toward the bottom of the container over time. The formed gel particles are distinctly separate environments, i.e., physically, configurationally, structurally and visibly, from the medium from which they were formed. The gel particles have measurable sizes and are separate physical entities from the carrier medium within which they are formed and suspended. The gel particles are malleable, “soft” and flexible entities, and can be mechanically adhered to other inert particles within the suspending medium forming a sort of cushion around an inert particle serving to increase that inert particle's capacity for suspension within the medium. The gel particles contain molecules of the carrier medium from which they were formed within the gel-particle itself. Though “micro” in size, gel particles can vary greatly in their physical structure and size from ˜2-3 μm to 500 μm, or perhaps even larger depending on the size of the molecular or polymeric components from which they are prepared. The formed gel particles are not emulsions, sols, gels, or soluble particles, although they contain molecules of the carrier medium within them, they are distinct, semi-gelatinous particles that are completely separate and distinct entities and environments from the carrier medium. Once formed, the gel particle is no longer reactive with the medium from which it was formed. It does contain molecules of the carrier within it, but there is no further chemical reaction with the carrier medium. Though the gel particles of invention are not emulsions, nor do they have the properties of emulsions by definition, they are considered to be “semi-solid” particles that share properties of solid particles, gels and emulsions together. However, they do not fit into any one of these categories of matter.

Gel-particles, as suspending particles, primarily exist only under conditions where they are kept “wet” with the carrier molecules within the particle maintained intact. If dried, or allowed to “evaporate” or have the carrier medium molecules removed from the gel-particle, the suspension features of the particle will fail and the “dried” particle will cease to exhibit any abrasive or inert particle suspension properties.

There are a number of examples of gel particles that will satisfy the characteristics and properties of the present invention. These potential gel particle materials fall into a number of groupings that can be described as follows:
a) Alkaline earth metal hydroxides and oxide-hydrates, i.e., Mg(OH)₂; Mg0-x H₂O);
b) Alkaline neutralized salts of transition metals in water or other caustic media using Bronsted or non-Bronsted base to neutralize in-situ salts of Fe, Cr, Al, Zn, Cu, Ni, and others where the in-situ final product formed is a “hydrated” or carrier impregnated hydroxide of the metal that may also be called a hydrous-oxide;
c) Silicates, ortho-silicates and certain poly-Silicates;
d) Modified Starches, both synthetic and natural (ie; such as corn starch and others)
e) Cellulose derivatives such as, but not limited to: Hydroxy cellulose, Hydroxy propyl cellulose, Methyl carboxymethyl cellulose ,Acetyl cellulose;
f) Polysaccharides formed outside the suspending medium, but “ground” into distinct gelatinous particles after long mixing with the suspended medium, then ground into gel-particles that may act as suspending particles, and re-suspended within the carrier medium, such as, but not limited to: Guar, Guar gum, Agar, Agar-Guar mixtures, Carrageenans, Pectins, Gellan gum, Alginates and metal alginates (Calcium alginate), plant derived polysaccharides and mixtures of these materials;
g) Polyelectrolytes in non-ionic, polar organic carriers that may include: Sulfonated polystyrene (PSS), Poly acrylic acid, methacrylic acid, maleic acid, or copolymers thereof (neutralized or partially neutralized) (PAA), Ammonium poly (methacrylate) (APMA), Poly ester amide and co-polymers of said Poly amines, Poly-(amino acid) polyelectrolytes, e.g., Poly (L-aspartic acid) (PAA), Poly (L-glutamic acid), (PGA) and Poly (L-Lysine) (PLL).
   With common properties and characteristics independent of formation mechanism or origin “gel particles” for applications relevant to this invention all have many common properties, behavior and characteristic threads binding the vast diversity of structures, compounds, polymers and materials together. Regardless of formation mechanism or origin, all “gel particles”, as defined and described in the examples above, have the same common performance and behavioral properties required for the useful applications noted above.

Polysaccharides have been used as coating compositions in an aqueous carrier. One such example of formation of a coating composition begins with the preparation of modified polysaccharides by suspending 5 g of selected pure polysaccharides-agar and guar gum in 100 ml of distilled water. The suspensions were stirred at 500 rpm using a magnetic stirrer for 24 hours. The obtained swollen masses were spread out on enameled trays and dried at 40° C. for 72 hours. The dried product was scrapped out of the trays and crushed in a glass pestle mortar to obtain coarse, non-free flowing heterogeneous particles of treated polysaccharides-treated agar and treated guar gum. The treated polysaccharides were then co-grinded with mannitol in a 1:1 ratio in a glass pestle mortar for 20 minutes and passed through a #22 sieve to obtain the modified polysaccharides-co-grinded treated agar and co-grinded treated guar gum. The resulting product was then used as a gelatinous coating for pharmaceuticals for ingestion by humans. This example suggests that gel particles can be made by other means than just the mixing of appropriate compositions in liquid carriers, but still retain the properties and characteristics discussed in regard to this invention.

Polysaccharides have also been used to form gelatinous particles to assist in the construction of foundation walls as a substitute to thicken water utilized to maintain the open trenches while preventing the water that is keeping the trenches from inward collapse from migrating into the soil. When added to the water polysaccharides, e.g., starch, guar, carboxymethylcellulose, sugar beet pulp derivative and hydroyethylcellulose, which have suitable viscosity and solvation properties, produced a thickened gelatinous slurry which does not rapidly convert to a solution. It was found that the polysaccharide polymers have a long solvation time either when added to water as a powder or in the form of an oil-based slurry. This is an example of a different polymer being utilized either as a powder or as an organic slurry to form gel-particles for use in the main carrier system.

Polyelectrolytes are “dipole” charged polymers capable of stabilizing (or destabilizing) colloidal emulsions through electrostatic interactions. The effectiveness of polyelectrolytes is dependent upon molecular weight, pH, solvent polarity, ionic strength, and the hydrophilic-lipophilic balance. Polyelectrolytes are made up of positively or negatively charged repeat units. Polyelectrolytes become charged through the dissociation of monomer side groups. If a greater number of monomer side groups are dissociated, the resulting charge will be greater. The charge of the polymer classifies the polyelectrolyte as positive (cationic) or negative (anionic). It is the level of the charge and the ionic strength of the polyelectrolyte that dictates how thick a polyelectrolyte layer will be. Some examples of useful polyelectrolytes are listed above.

### EXAMPLE 7

Also of concern is gel-particle distribution in the carrier system in order to maintain separation between the gel particles and the added abrasive or inert particles. A test was conceived to determine whether gel-particle dilution would vary the effectiveness of the gel particles in preventing agglomeration of the added abrasive or inert particles in the slurry. A water-based aqueous solution with formed gel particles was prepared. All testing was performed at ambient temperature, 22° C., with a constant volume of 40 ml regardless of dilution factor. The following Table 7 shows the dilution factors with the Suspension Volume Retention [SVR] expressed as a % of the original suspension volume of 40 ml in a calibrated container.

TABLE 7

| Gel | Day 1 - [t = 0]* | | Day 2 | | Day 21 | |
|---|---|---|---|---|---|---|
| Particle | SVR | % of | SVR | % of | SVR | % of |
| Dilution | in | Original | in | Original | in | Original |
| Ratio | ml | Suspension | ml | Suspension | ml | Suspension |
| 3:1 | 40 | 100 | 28.75 | 72 | 27 | 67.5 |
| 5:1 | 40 | 100 | 20 | 50 | 17.5 | 44 |
| 6:1 | 40 | 100 | 21.25 | 53 | 19 | 47.5 |
| 8:1 | 40 | 100 | 18.75 | 47 | 17 | 42.5 |
| 9:1 | 40 | 100 | 17.5 | 44 | 15 | 37.5 |
| 10:1 | 40 | 100 | 16 | 40 | 12.5 | 31.3 |

*t = 0 refers to freshly prepared suspensions where SVR is at 100% indicating settling has yet to occur.

Reduction of SVR over time is only possible when gel particle density is greater than that of the medium in which it is suspended. Regardless of dilution level of the gel-particle slurry, SVR values for all of the samples decreases over time showing the density of the gel-particles and suspended particles are greater than the aqueous suspension medium. In fact, the greatest degree of “soft-settling” of the gel-particles and suspended particles occurs during the first 24 hour period for all gel particle dilution levels.

The foregoing examples are by no means meant to be all inclusive or complete, but, for any material, compound, polymer (whether organic, metal organic or inorganic in nature) that meets the common performance and behavior properties of the unique “inert particle stabilization/suspension” criteria and properties listed above; all of these diverse materials simply become different examples of the same unique concept of “gel-particles” that have common, but unique properties required for the long-term stabilization of other inert particles that otherwise would settle out into a hard or solid agglomerated cake at the bottom of the carrier system container.

Therefore, regardless of “gel particle” origin, nature of the particular components of the compound, material or polymer from which it is formed; whether organic, metal-organic or inorganic in structure, and whether said gel particle exists within an organic or inorganic or combination liquid carrier system, all of the series of described components are just diverse examples of the same type of unique form of gelatinous matter having the necessary properties and characteristic to serve as the suspending particle(s) in the carrier medium or system.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for the suspension of inert colloidal or non-colloidal abrasive or non-abrasive inert particles in a stable aqueous, semi aqueous or organic carrier medium which comprises producing in-situ formed suspending particles, so as to establish an appropriate concentration of suspending particles to inert particles to produce sufficient interference to settling of said inert particles in said carrier medium, said carrier medium comprising a range from 0.1 to 60% by weight of the suspending particles, which differ from said inert particles, and are selected from the group consisting of alkaline earth metal and transition metal hydroxides, oxy hydroxides, and oxide hydrates that form in-situ said suspending particles within and inclusive of said carrier medium at a pH between 4 and 12, the in situ formation of the suspending particles in the carrier medium resulting in the suspending particles exhibiting substantially uniform properties of having distinctly different molecular, configurational, rheological and physical structures than the carrier medium, a density greater than that of the carrier medium, visually identifiable and separate physical structure than the carrier medium, measureable size differences in a range between approximately 2-3 μm and 500 μm, and containing molecules of the carrier within which the suspending particle was formed but without a capacity for further reaction with the carrier medium, and independent of formation mechanism or origin of components, whereby said inert particles are suspended in said carrier medium by at least one of physical interference between the suspending particles and the inert particles, attracting forces between the suspending particles and the inert particles to provide a proximity for chemical, physical or physicochemical interference, and electrostatic charge repulsion of the suspending particles from the inert particles and themselves, all to prevent agglomeration or coagulation of said inert particles in said carrier medium over an extended period of time.

2. The method of claim 1 wherein said suspending particles are formed in a separate medium from the final carrier medium.

3. The method of claim 1 wherein said aqueous carrier medium contains at least one inert polar solvent.

4. The method of claim 3 wherein said inert polar solvent is selected from the group consisting of dialkylene glycol, alkylene glycol, glycol ether, polyalkylene glycol, alkyl lactone, N-methyl pyrrolidone, alkylene carbonates, acetonitrile, and dimethyl acetamide.

5. The method of claim 1 wherein said suspending particles are gel particles, sol gel particles, and gelatinous precipitates formed from alkaline earth metal or transition metal hydroxides, oxy hydroxides, or oxide hydrates.

6. The method of claim 5 wherein said suspending particles are formed from a member selected from the group consisting of aluminum hydroxide, aluminum oxy hydroxide, zinc hydroxide, copper hydroxide, magnesium hydroxide and tin hydroxide.

7. The method of claim 1 wherein said suspending particles are gel particles, sol gel particles, and gelatinous precipitates formed from alkaline neutralized salts of transition metals formed in an aqueous or caustic media using Bronsted or non-Bronsted base to neutralize in situ salts of Fe, Cr, Al, Zn, Cu, Ni and the like such that the suspending particles are hydrous-oxides of the metal.

8. The method of claim 1 wherein said suspending particles are gel particles, sol gel particles, and gelatinous precipitates formed from modified starches, cellulose derivatives including hydroxyl cellulose, hydroxyl propyl cellulose, methyl carboxymethyl cellulose and acetyl cellulose.

9. The method of claim 1 wherein said suspending particles are gel particles, sol gel particles, and gelatinous precipitates formed from polysaccharides formed outside of the carrier medium including guar, guar gum, agar, agar-guar mixtures, carrageenans, pectins, gellan gum, alginates and metal alginates, plant derived polysaccharides and mixtures thereof.

10. The method of claim 1 wherein said suspending particles are gel particles, sol gel particles, and gelatinous precipitates formed from polyelectrolytes formed in non-ionic or polar carrier media including sulfonated polystyrene, poly-acrylic acid, methacrylic acid, maleic acid or copolymers thereof, ammonium poly (methacrylate), poly ester amide and co-polymers of poly amines, and poly-(amino acid) polyelectrolytes.

11. The method of claim 1 wherein said inert particles being suspended are selected from the group consisting of titanium dioxide, silicon carbide, zirconium oxide, silica, cerium oxide, aluminum oxide, silicon nitride, boron carbide, tungsten carbide, diamond, silicon dioxide and dry pigment particles.

12. The method of claim 1 including a corrosion inhibitor.

13. The method of claim 1 including an inert salt to provide further density difference or electrostatic repulsion between suspended particles and inert particles.

14. The method of claim 13 including the removal of inert salt produced by the formation of the suspending particles.

15. A suspending gel particle formed in situ in a stable aqueous, semi-aqueous or organic carrier medium for the suspension of inert colloidal or non-colloidal abrasive or non-abrasive inert particles in said stable carrier medium, said suspending gel particles, which differ from said inert particles, comprising a range from 0.1 to 60% by weight with said carrier medium so as to establish an appropriate concentration of suspending particles to inert particles to produce sufficient interference to settling of said inert particles in said carrier medium, said suspending gel particles being selected from the group consisting of alkaline earth metal and transition metal hydroxides, oxy hydroxides, and oxide hydrates that form in-situ said suspending particles within and inclusive of said carrier medium at a pH between 4 and 12, the in situ formation of the suspending particles in the carrier medium resulting in the suspending gel particles exhibiting substantially uniform properties of having distinctly separate molecular, configurational, rheological and physical structures than the carrier medium, a density greater than that of the carrier medium, visually identifiable and separate physical structure than the carrier medium, measureable size differences in a range between approximately 2-3 μm and 500 μm, and containing molecules of the carrier within which the suspending particle was formed but without a capacity for further reaction with the carrier medium, and independent of formation mechanism or origin of components, whereby said inert particles are suspended in said carrier medium by at least one of physical interference between the suspending gel particles and the inert particles, attracting forces between the suspending particles and the inert particles to provide a proximity for chemical, physical or physicochemical interference, and electrostatic charge repulsion of the suspending gel particles from the inert particles and themselves, all to prevent agglomeration or coagulation of said inert particles in said carrier medium over an extended period of time.

16. The suspending gel particles of claim 15 being malleable, flexible separate physical entities from said carrier medium can be mechanically adhered to any of said inert particles within the carrier medium forming a cushion around said inert particle and serving to increase the suspendability of the inert particle within the carrier medium.

17. The suspending gel particles of claim 15 wherein said gel particles will continue to exist only in conditions such that said gel particles remain semi-liquid with the carrier molecules within the gel particle maintained intact.

18. The suspending gel particles of claim 15 having component chemical compounds selected from the group containing alkaline earth metal hydroxides and oxide hydrates, alkaline neutralized salts of transition metals, silicates, ortho-silicates and certain poly-silicates, modified starches, cellulose derivatives, polysaccharides, and polyelectrolytes in non-ionic, polar organic carriers.
